(19) United States
(12) Patent Application Publication
(10) Pub. No.: US 2017/0222863 A1
(43) Pub. Date: Aug. 3, 2017

(54) CLOUD COMPUTER REALIZED IN A DATACENTER USING MMWAVE RADIO LINKS FOR A 3D TORUS

(71) Applicant: HGST Netherlands B.V., Amsterdam (NL)

(72) Inventor: Luiz M. FRANCA-NETO, Sunnyvale, CA (US)

(21) Appl. No.: 15/011,539

(22) Filed: Jan. 30, 2016

(51) Int. Cl. H04L 12/24; H04W 72/04; H04B 1/16; H01Q 21/06; H01Q 1/52

(52) U.S. Cl. CPC H04L 41/04; H01Q 21/065; H01Q 1/52; H04B 1/16; H04W 72/0453

(57) ABSTRACT

The present disclosure generally relates to a high performance datacenter computer (HPDC) that utilized mmWave links to communicate between servers at opposing racks across the datacenter aisles. The HPDC includes stacks of servers with the stacks arranged in rows. The HPDC includes multiple rows. Within the stacks and rows, the various servers are wired together, but between opposing rows, mmWave technology is used to communicate.

### BACKGROUND OF THE DISCLOSURE

Field of the Disclosure

Embodiments of the present disclosure generally relate to a cloud computer datacenter system that uses mmWave radio links between opposing servers across the datacenter aisles and cooper-based backplanes between servers in the same rack or servers in neighbor racks in the same aisles.

Description of the Related Art

High Performance Computing (HPC) achieves record performance in data processing by the use of very low latency, proprietary, massive interconnect networks among all processing nodes. HPCs are typically applied to one application running on one operating system (OS), and using all available processing nodes. HPCs are priced at millions of dollars per installed realization.

Comparatively, grid and cloud computing run many applications on multiple OS simultaneously. Being sensitive to cost, cloud computing uses largely available resources. An assembly of servers, which include a processor, memory and storage using standard buses and I/O controllers, are typically deployed. All of these servers are interconnected by largely available switches. For general purpose and lower cost realizations, Ethernet switches are used. In higher performance realizations, InfiniBand switches are used.

Switches in cloud computing are responsible for large latencies when the network is heavily loaded relative to when the network is unloaded or lightly loaded, which is due to competition for resources in the switch and rely on packets of data being held in buffers or discarded. In the case of packets being discarded, those packets need to be resent.

Therefore, there is a need to find a low latency solution for interconnects that can avoid contention in the network. A solution that can be low cost and can easily be adopted in cloud computing. And since typical datacenters use a top of the rack (ToR) switch, the collaboration in data processing is mostly rack-based. A solution is needed that can also scale across adjacent racks and across aisles in a datacenter.

### SUMMARY OF THE DISCLOSURE

The present disclosure generally relates to a high performance datacenter computer (HPDC) that utilized mmWave links to communicate between servers at opposing racks across the datacenter aisles. The HPDC includes stacks of servers with the stacks arranged in rows. The HPDC includes multiple rows. Within the stacks and rows, the various servers are wired together, but between opposing rows, mmWave technology is used to communicate.

In one embodiment, a datacenter computer comprises a first server, wherein the first server comprises a first mmWave antenna/receiver; a second server physically coupled to the first server, wherein the second server comprises a second mmWave antenna/receiver; and a third server physically spaced from the first and second servers, wherein the third server comprises a third mmWave antenna/receiver, wherein the first mmWave antenna/receiver is both horizontally and vertically aligned with the third mmWave antenna/receiver.

In another embodiment, a datacenter computer comprises a plurality of servers, wherein the servers are arranged in a plurality of stacks, wherein the plurality of stacks are arranged in a plurality of rows, wherein within each stack a first plurality of servers of the plurality of servers are coupled together with a physical connection, wherein within each row adjacent stacks that each have a plurality of servers are coupled together with a physical connection, wherein adjacent rows are spaced apart, wherein a first server in a first row is both vertically aligned and horizontally aligned with a second server in a second row, and wherein the first server has a first mmWave antenna/receiver that is both vertically aligned and horizontally aligned with a second mmWave antenna/receiver that is disposed in the second server.

In another embodiment, a datacenter computer comprises a first stack of servers, wherein the first stack of servers comprises a plurality of first servers, wherein a first server and a second server of the plurality of first servers are physically coupled together, wherein the first server comprises a first mmWave antenna/receiver and the second server comprises a second mmWave antenna/receiver; a second stack of servers disposed adjacent the first stack of servers, wherein the second stack of servers comprises a plurality of second servers, wherein a third server and a fourth server of the plurality of second servers are physically coupled together, wherein the first server is physically coupled to the third server, wherein the third server comprises a third mmWave antenna/receiver and the fourth server comprises a fourth mmWave antenna/receiver; and a third stack of servers disposed adjacent the first stack of servers, wherein the third stack of servers comprises a plurality of third servers, wherein a fifth server and a sixth server of the plurality of third servers are physically coupled together, wherein the first stack of servers and the second stack of servers are arranged in first row, wherein the third stack of servers is a part of a second row distinct from and spaced from the first row, wherein the fifth server comprises a fifth mmWave antenna/receiver and the sixth server comprises a sixth mmWave antenna/receiver, and wherein the first mmWave antenna/receiver is both vertically and horizontally aligned with the fifth mmWave antenna/receiver.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic illustration of a HPDC according to one embodiment.

FIG. 2 is a schematic illustration of a 3D torus arrangement for a HPDC according to one embodiment.

FIG. 3A is a schematic cross-sectional illustration of a HPDC row of servers according to one embodiment.

FIG. 3B is a schematic illustration of a ring connection arrangement.

FIG. 3C is a schematic illustration of a folded ring connection arrangement.

FIG. 3D is a schematic illustration of a HPDC row of servers from FIG. 3A illustrating sliding the servers into place.

FIG. 4A is a schematic illustration of the HPDC of FIG. 1.

FIG. 4B is a schematic illustration of the server arrangement in FIG. 4A.

FIGS. 5A and 5B are schematic illustrations of a server according to one embodiment.

FIG. 5C illustrates how two different polarizations for mmWave links can be obtained by physical orientation of the patch antenna array feed.

FIG. 5D illustrates a patch antenna array feed strategy where the feeding signal is first brought to the center of the array and then distributed to each patch accruing equal delays.

FIG. 5E illustrates how a multilayer structure allows for placing two patches tuned to slightly different frequencies in the interest of designing a wider band patch antenna.

FIG. 5F illustrates a multiplicity of wide band mmWave channels available for use a datacenter.

FIG. 5G illustrates a receded mount for pairs of patch antenna array supporting full duplex link operation.

FIG. 6 is a flowchart illustrating the operation of a HPDC according to one embodiment.

FIG. 7 illustrates a datacenter that supports high level remote memory access (RMA) services.

FIG. 8 illustrates an embodiment where the router chip (HPDC router) intercepts READ and WRITE commands and access either NVM storage on the same server motherboard or NVM storage on a remote motherboard.

FIG. 9 illustrates circuits that can partially serialize 64 bit channels into a 8-bit wide bus.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a high performance datacenter computer (HPDC) that utilized mmWave to communicate between opposing servers across an aisle. The HPDC includes stacks of servers with the stacks arranged in rows. The HPDC includes multiple rows. Within the stacks and rows, the various servers are wired together, but between opposing rows, mmWave technology is used to communicate.

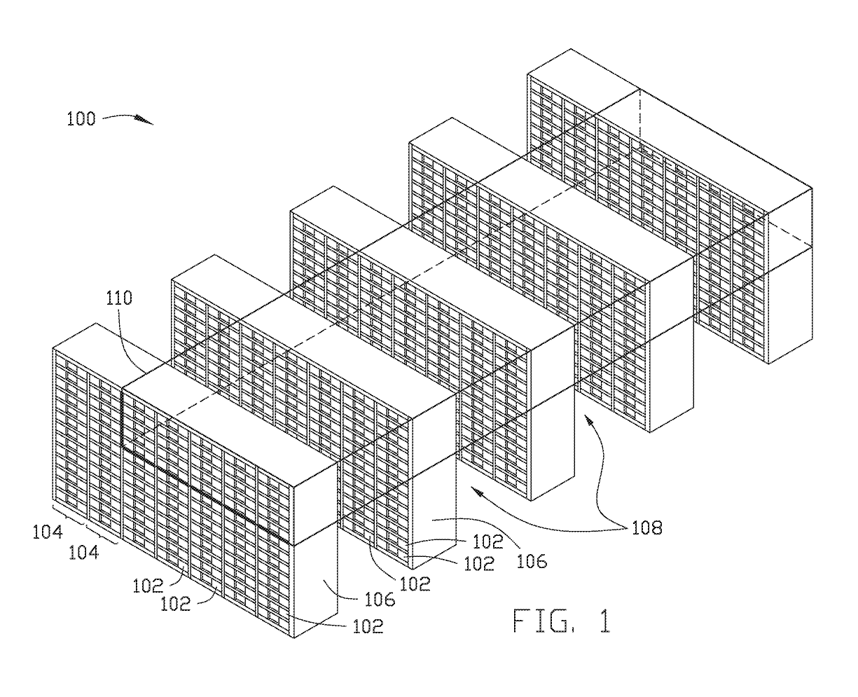

FIG. 1 is a schematic illustration of a HPDC 100 according to one embodiment. The HPDC 100 includes a plurality of servers 102. The servers 102 are arranged in a plurality of stacks 104, and the plurality of stacks 104 are arranged in a plurality of rows 106. Each row 106 is spaced from an adjacent row 106 by an aisle 108. A cluster 110 of five servers 102 by five stacks 104 by five rows 106 is identified in FIG. 1. It is to be understood that the cluster 110 is not limited to such an arrangement, but rather, can include more or less servers 102, stacks 104 and rows 106. The cluster 110 of five by five by five is for exemplification purposes only. The stack of servers has square openings on their front panel. These square openings allow for the high data rate mmWave communication beams to be transmitted or received by a server. The square opening may be a feature of the front panel.

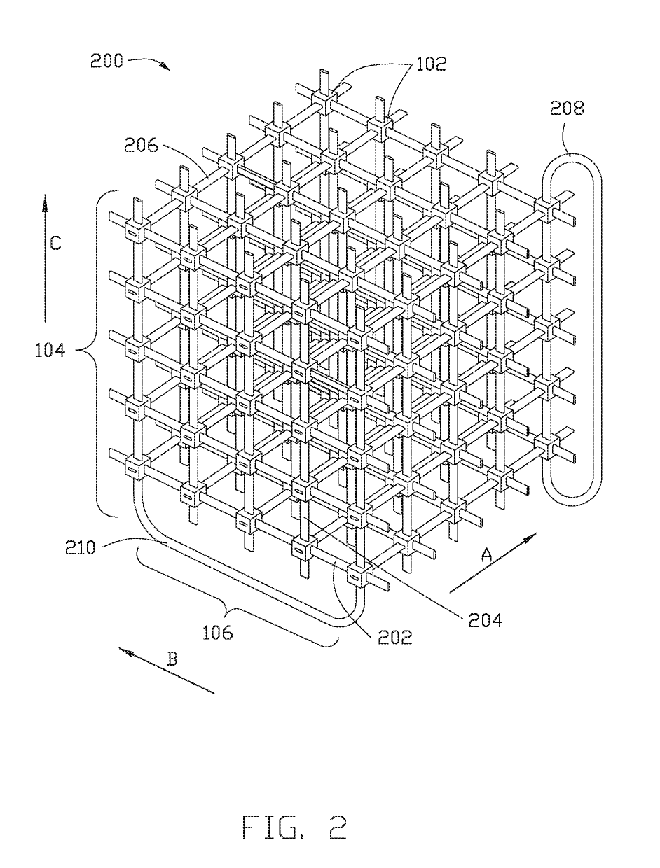

FIG. 2 is a schematic illustration of a 3D torus arrangement 200 for a HPDC 100 according to one embodiment. This 3D torus is a hybrid with copper-based and mmWave based communication rings. The arrangement 200 is a five by five by five cluster of servers 102, stacks 104 and rows 106. Arrow “A” shows the direction across the aisles 108, arrow “B” shows the direction along a row 106, and arrow “C” shows the direction along a stack 104. The thick black connectors between cubes, which represent servers, are copper-based communication links while the colored connectors are mmWave links.

The arrangement 200 shows the physical connections 202, 204 within the stacks 104 and rows 106, but also shows the mmWave communication path 206 between the rows 106. The physical connections are point-to-point communication links. In the arrangement 200, servers 102 that are adjacent one another within a stack 104 are physically connected with a connection 204. The physical connection 204 is to the server 102 disposed directly adjacent thereto. Thus, each server 102 within a stack 104 has two physical connections 204 within the stack 104. The servers 102 on the ends of the 5 server stack 104 are coupled to each other with a physical connection 208 as well. Similarly, within the rows 104, the adjacent servers 102 are physically coupled together with a connection 202 and the servers 102 at the ends of the 5 stack rows 106 are coupled to each other with a physical connection 210 as well. Thus, each server 102 in a row 104 has two physical connections within a row 106. In total, each server has 4 physical connections, two connections to the servers 102 adjacent thereto in a stack 104, and two connections to servers 102 adjacent thereto in the rows 106. In addition to the physical connections 202, 204 within the stacks 104 and rows 106, the mmWave communication paths 206 are present. The mmWave communications paths 206 shows that a servers 102 is a particular rows 108 is both horizontally and vertically aligned with a corresponding server 102 in an adjacent row. Thus, the mmWave antennas/receivers, which will be discussed below, are both horizontally and vertically aligned with corresponding mmWave antennas/receivers in an adjacent row.

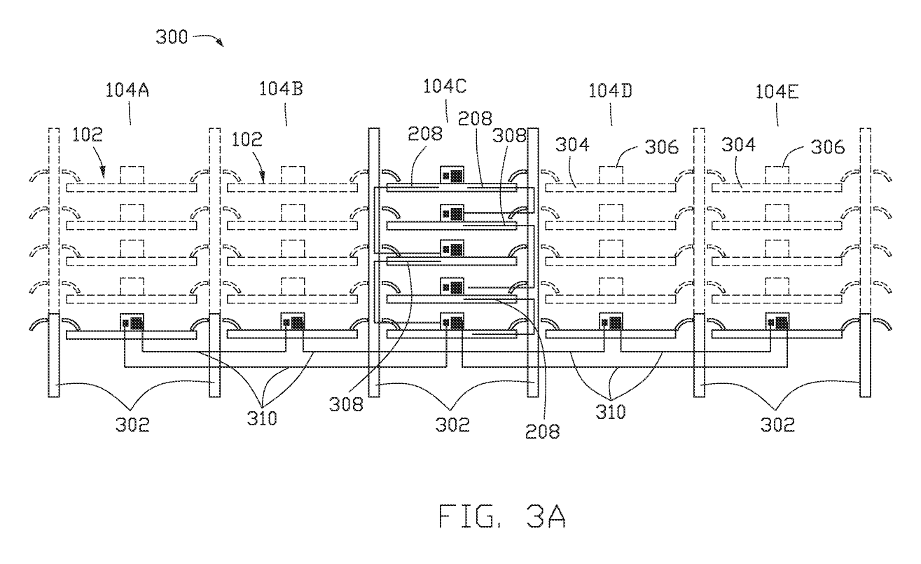

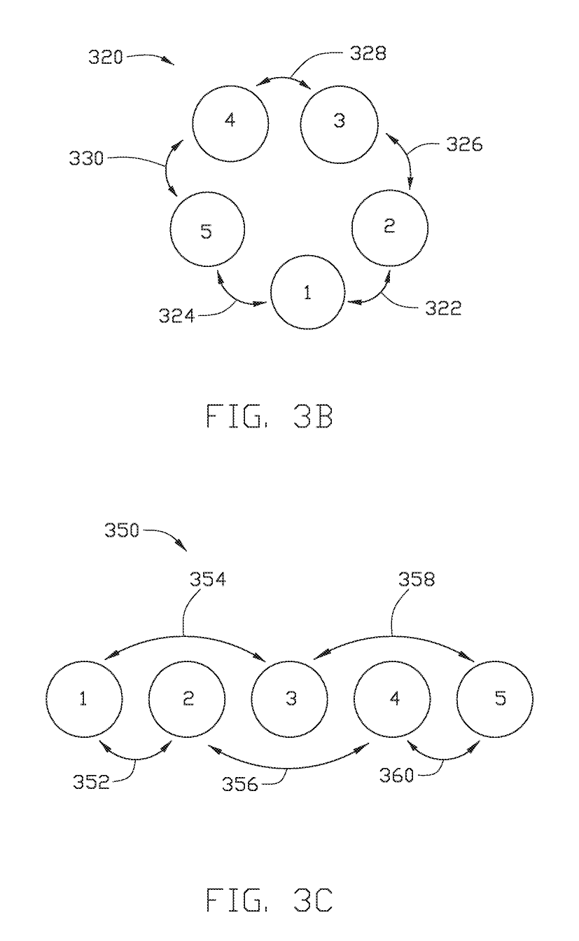

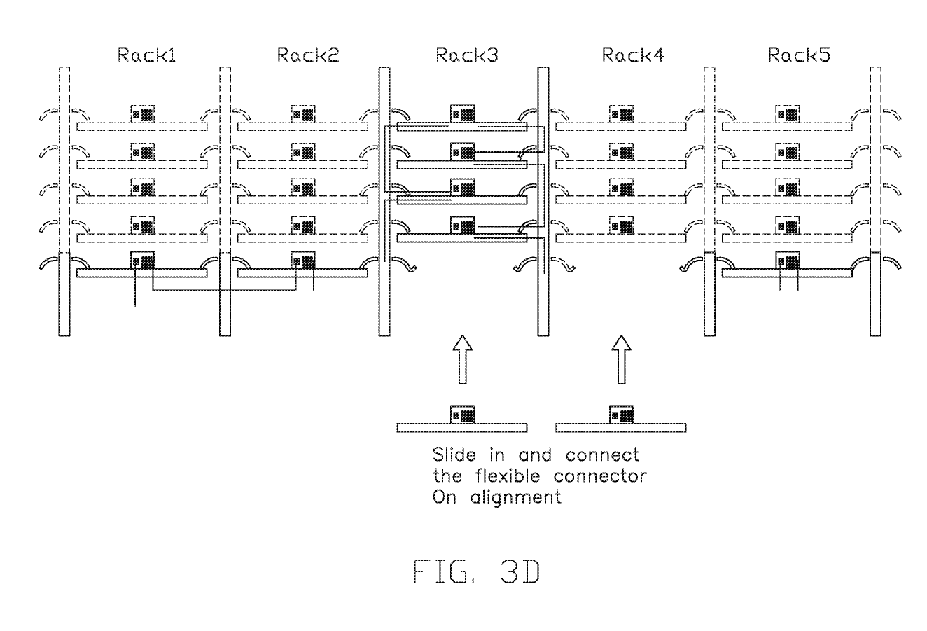

FIG. 3A is a schematic cross-sectional illustration of a HPDC row of servers 300 according to one embodiment. The row of servers 300 includes five stacks 104A-104E. Each stack 104A-104E includes five servers 102. The stacks 104A-104E are bordered by walls that have high performance backplanes 302 thereon. The servers 102 include motherboards 304 to carry router to router communications. The servers 102 also include mmWave antennas/receivers 306. As shown in FIG. 3A, within a stack 104A-104E, there are two physical connections 308 between the servers 102 for a total of only 5 connections within a stack 104A-104E that includes 5 servers 102. Thus, the total number of connections for within stack communication is equal to the total number of servers 102. Between adjacent stacks, there are physical connections 310 as well. Each server 102 has two physical connections 310 such that the total number connections for stack to stack communication are equal to the number of stacks. Thus, it should be understood that while a total of five serves within a stack and a total of five stacks have been shown, more or less stacks and servers may be present. To make the physical connections 308 within a stack 104A-104E, and to make the physical connections between stacks 104A-104E, a ring arrangement or a folder ring arrangement may be used.

The skilled in the art will recognize that the above arrangement of servers and the use of copper-based backplane and motherboards to support the router to router communications differ from the practice in standard cloud datacenters. In standard cloud datacenters, racks only provide mechanical support for the servers. In standard datacenters, communication from server to server needs the intermediation of network switch boxes, typically mounted at the top of each rack. Communication from server to switch is made with cables, typically category 5 (CAT5) or category 6 (CAT6) Ethernet cables. Moreover, the communication between servers across rack as taught herein will be recognized by those skilled in the art to be another innovation from a standard datacenter.

FIG. 3B is a schematic illustration of a ring connection arrangement with bidirectional communication links 320. The arrangement 320 includes 5 objects which could be servers 102 or stacks 104. The objects are labeled 1-5. It is to be understood that 5 objects is merely an example and more or less objects may be present. Object 1 has a connection 322 to object 2 and a connection 324 to object 5. Object 2 has the connection 322 to object 1 and a connection 326 to object 3. Object 3 has the connection 326 to object 2 and a connection 328 to object 4. Object 4 has the connection 328 to object 3 and a connection 330 to object 5. Object 5 has the connection 330 to object 4 and the connection 322 to object 1. The connections 322, 324, 326, 328, 330 are all physical connections and comprise wires to permit communication in both directions. The connections include two unidirectional channels to permit data to flow in a single direction. The ring arrangement 320 is one embodiment of how to connect servers 102 within a stack 104 or to connect adjacent stacks 104 within a row 106.

Since servers in a datacenter are going to be arranged in linear arrangements, the conceptual ring of FIG. 3B need to be folded into a linear arrangement. FIG. 3C is a schematic illustration of a folded ring connection arrangement 350. The folder ring arrangement 350 is shown to include 5 objects labeled 1-5. Again, as in FIG. 3B, it is to be understood that 5 objects are used for exemplification purposes and thus, more or less objects may be present. Here, each object 1-5 has two connections, but at least one of the connections is to another object that is not directly adjacent thereto. For example, object 1 has a connection 352 to object 2 which is directly adjacent thereto, but also a connection 354 to object 5 which is not directly adjacent thereto. Similarly, object 2 has the connection 352 to object 1, but also a connection 356 to object 3 which is not directly adjacent thereto. Object 3 has the connection 356 6o object 2, but also a connection 360 to object 4 which is directly adjacent thereto. Object 4 has the connection 360 to object 3, and a connection 358 to object 5 which is not directly adjacent thereto. Object 5 has the connection 354 to object 1 which is not directly adjacent thereto and the connection 360 to object 4 which is also not directly adjacent thereto. Thus, objects 1-4 each have a connection to the object directly adjacent thereto and a connection to an object not directly adjacent thereto. Object 5, on the other hand, has two connections to objects not directly adjacent thereto and no connections to any object directly adjacent thereto. Also notice that the objects 1-5 in FIG. 3B and FIG. 3C are connected the same, but in FIG. 3B, each object is directly adjacent to the objects to which they are respectively connected whereas in FIG. 3C, each object is connected to an object that is not directly adjacent thereto.

Comparing FIGS. 3A and 3C, the skilled in the art will thus recognize that a motherboard of a first server support communication from adjacent second and third servers as if the motherboard of first server were a backplane for those second and third servers. This is referred to as motherboard-as-backplane feature as taught in this patent application.

The skilled in the art will recognize that because the short lengths involved the hybrid 3D torus-like network topology in thought in this document allows for communications at rates of 20 Gbps over copper-based and mmWave links. This is remarkable feature of the invention thought in this document that avoids expensive solutions using optical links or cable. The skilled in the art will recognize that wideband mmWave links operation from 50 GHz to 150 GHz carrier frequencies can be realized with ordinary large volume logic CMOS technology, the same technology used in the fabrication of large volume digital processors like Intel's or AMD's for example. High data throughput between servers is offered by the massive parallelization of links from server to server.

As shown in FIG. 3D, servers are slid into place, and once the flexible connectors are aligned to connectors on the server board, those flexible connectors are closed and the slid server gains electrical connection to the other servers in the same rack and also to servers in neighbor racks.

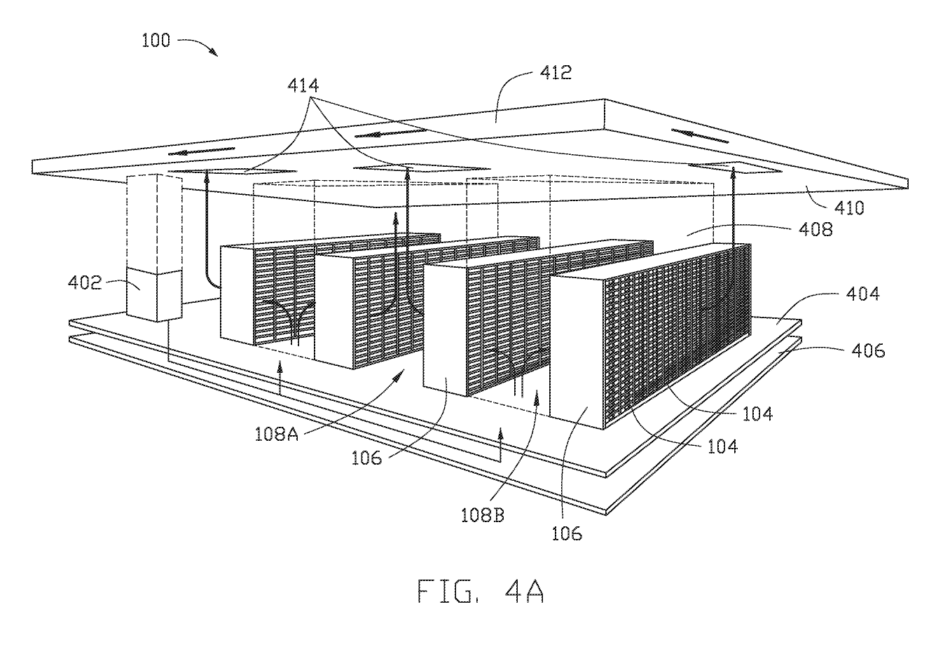

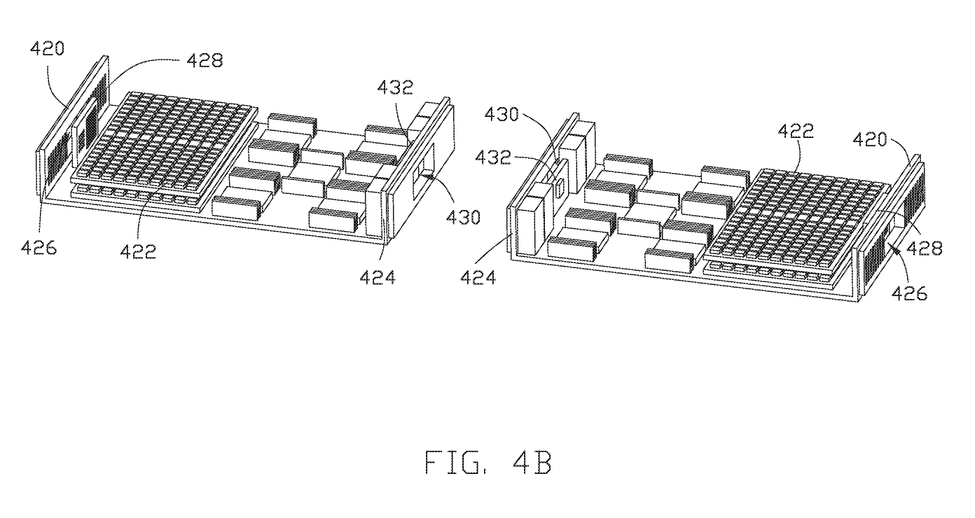

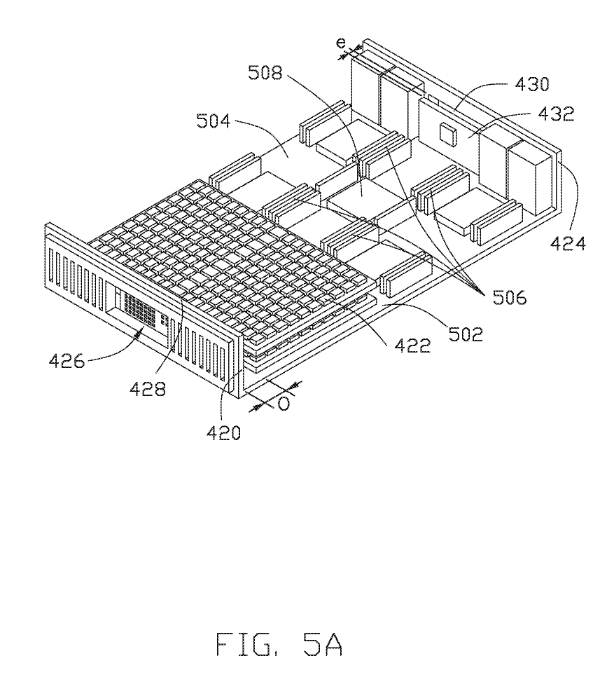

FIG. 4A is a schematic illustration of the HPDC 100 of FIG. 1. The HPDC 100 includes the servers 102, stacks 104 and rows 108. The HPDC 100 is arranged to ensure the servers 102 do not overheat and thus fail. In particular, an air circulation system is utilized to ensure the HPDC 100 remains at the desired temperature. Cool air from an air conditioner 402 is directed under the floor 404 to a plenum 406 where the cooled air is evenly distributed. The floor 404 has openings therethrough in specific aisles 108B of the HPDC 100 so that the cool air flows into specific aisles 108B and not other aisles 108A. The “cooling” aisle 108B can be surrounded by a curtain 408. The cool air is contained by the curtain 408 so that the cooled air has to flow through the individual servers 102. After flowing through the individual servers 102, the now warmer or hot air exists the servers into the hot air aisle 108A where there are no openings through the floor 404. The hot air rises up to the ceiling 410 and enters another plenum 412 through openings 414 in the ceiling 410. The warmed air in the plenum 414 is then directed back to the air conditioner 402. The HPDC 100 having the air circulation system described herein ensures that the servers 102 do not overheat because cool air is constantly directed through the individual servers 102 and the hot air is continuously removed from the servers 102.

FIG. 4B is a schematic illustration of the server arrangement in FIG. 4A. As shown in FIG. 4B, the servers 102 each have a first or “cooling” side 420 that is adjacent non-volatile memory elements 422, and a second or “warm” end 424 opposite thereto. The cool air enters the server 102 through an opening 426 in the first side 420 near the first mmWave antenna/receiver 428 and exits the server 102 through an opening 430 in the second side 424 near the second mmWave antenna/receiver 432.

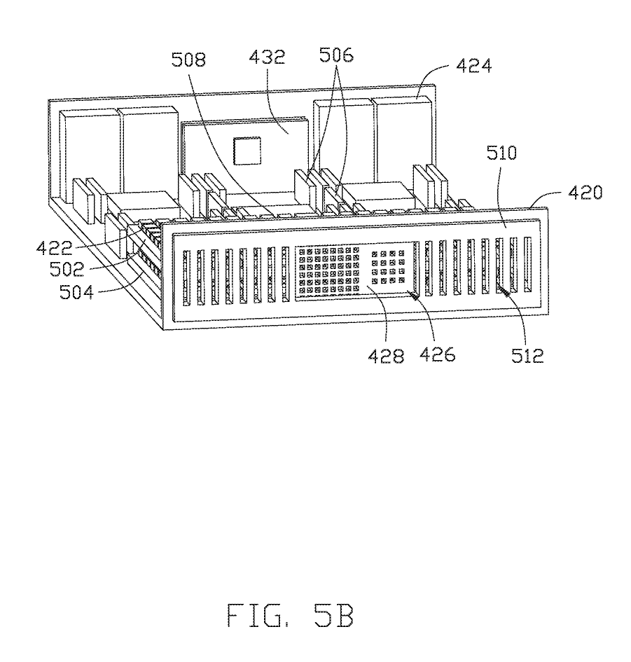

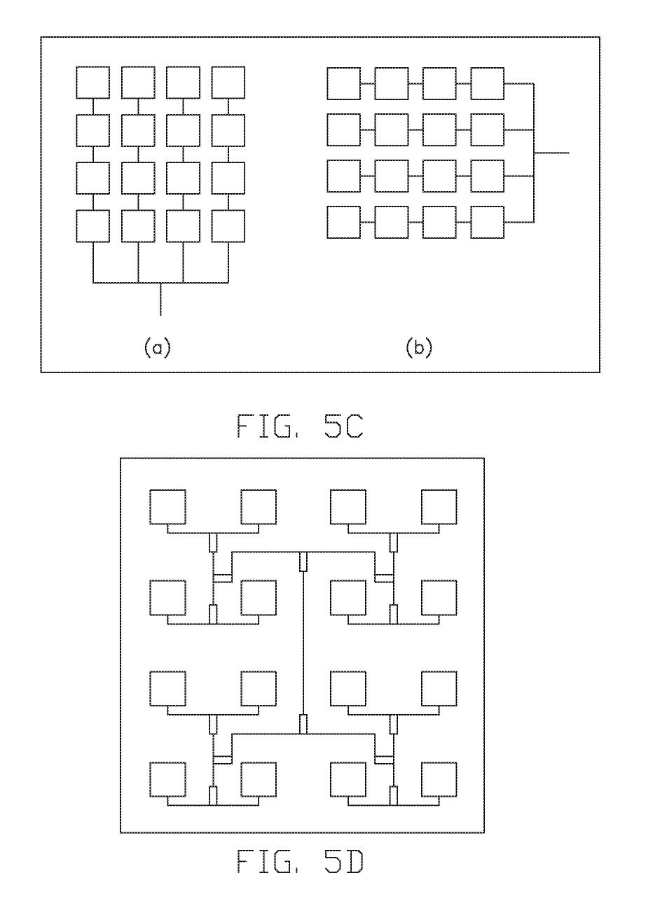

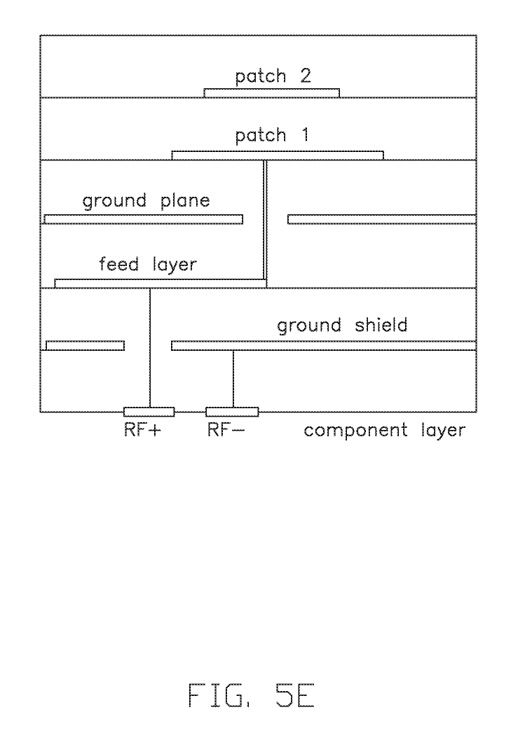

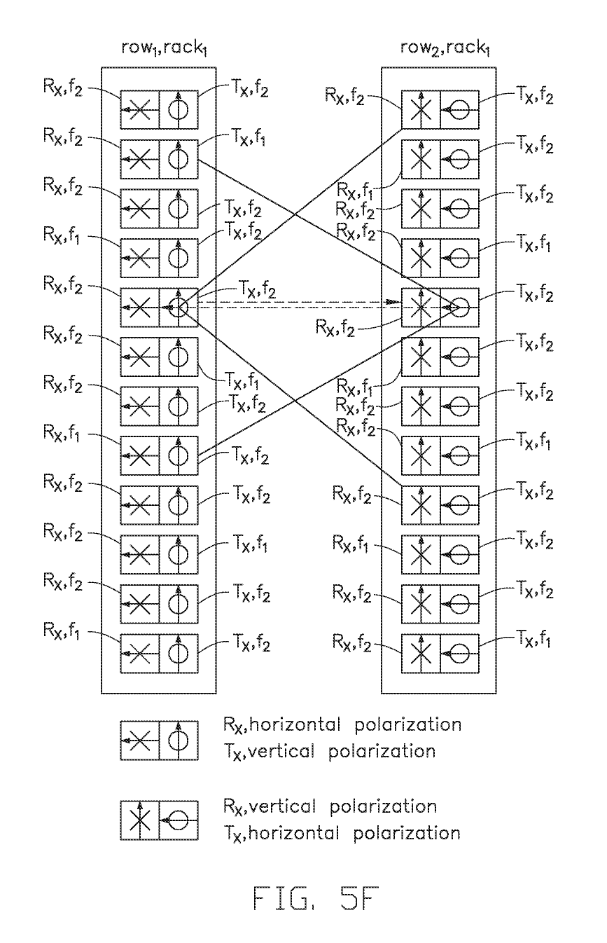

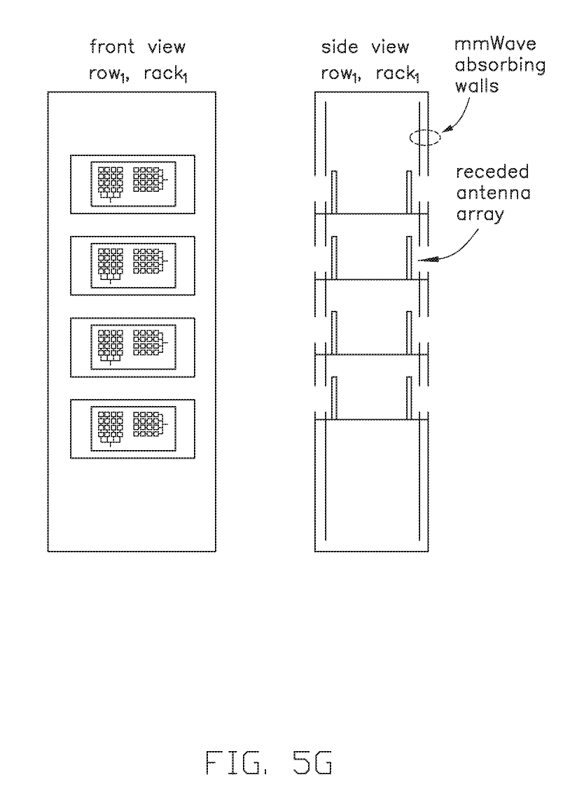

FIGS. 5A and 5B are simplified schematic illustrations of a server 102 according to one embodiment. The servers 102 comprise the nonvolatile memory elements 422 arranged on boards 502. It is to be understood that while two boards 502 are shown, more or less boards 502 are contemplated. The server 102 includes a motherboard 504 upon which the server elements are disposed. In addition to the nonvolatile memory elements 422, random memory access (RMA) cards 506 are present. It is to be understood that while 4 RMA cards 506 are shown, more or less RMA cards 506 are contemplated. A router 508 is also coupled to the motherboard 504. The antennas/receivers 428, 430 are patch antenna arrays mounted on the motherboard 504 of the server 102. The first mmWave antenna/receiver 428 is recessed from the first side 420 and opening 426 by a distance shown by arrow “D” and the second mmWave antenna/receiver 430 is recessed from the second side 424 and opening 430 by a distance shown by arrow “E”. The mmWave antennas/receivers 428, 430 are recessed so that the antennas/receivers 428, 430 are not exposed to too many mmWaves, but rather, are exposed to the specific mmWave signals from the server that is disposed directly across the aisle 108 therefrom and is at aligned both horizontally and vertically with the server 102. Stray signals are possible and thus, the disposal of the antenna/receiver 428, 430 at a location recessed from the sides 420, 424 helps to ensure the proper signal reaches the server 102. Additionally, the sides 420, 424 may be painted with a material 510 having nanoparticles that either absorb or scatter any impinging mmWave beams. Furthermore, the sides 420, 424 may have deep passages 512 therein so that hallow mmWave beams hit the lateral walls of the passages 512 and are either absorbed or scattered within the passages 512.

Those skilled in the art will recognize that the arrangement of fans on the side of the motherboard away from the non-volatile memory (NVM) chips assumes those NVM cells are better placed on the cold side of the server board away from the processors. If the NVM technology used better perform at higher temperatures, this can easily be accommodated by placing the fans on the side of the NVM cells, or away from the processor chips. This way, the NVM cells will be at the hotter side of the server motherboard.

FIG. 5C illustrates how two different polarizations for mmWave links can be obtained by physical orientation of the patch antenna array feed. FIG. 5D illustrate a patch antenna array feed strategy where the feeding signal is first brought to the center of the array and then distributed to each patch accruing equal delays. FIG. 5E shows how a multilayer structure allows for placing two patches tuned to slightly different frequencies in the interest of designing a wider band patch antenna. In the illustrated embodiment, patch1 is directly connected while patch2 is coupled by proximity. The supporting ground planes, and feed traces use different metal layers. The mmWave front-end integrated circuit components are placed at the surface at the back of the patch antenna array in this illustrative embodiment.

The low power (˜10 mW) mmWave signals used in the datacenter taught in this patent application can be properly shielded and confined to the interior of a datacenter without disturbing the other services the Federal Commission for Communication (FCC) reserves for mmWave radio frequencies in the open air. Hence, in a datacenter according to the teachings of this invention disclosure can define significantly wider mmWave communication channels. For instance, 10 (ten) 5 GHz wide channels can be defined from 100 GHz to 150 GHz carrier frequencies. Depending on the distance across the aisles and directivity (gain) of the patch antenna array used, spectral efficiencies of 4 bits/Hz can be reached. Thus, in one embodiment using 5 GHz channels, 20 Gbit/second data rates can be achieved. These rates are already at pair or higher than rates typically used in fiber optics communications using a single wavelength laser source.

The skilled in the art will recognize that it's the choice of a hybrid 3D torus like network topology employing short communication links that enabled the low cost and high data rate of copper based backplanes and mmWave wireless links to their most effectiveness, enabling the design of a datacenter with high data throughput by massive parallelization of communication channels. Low cost is also enabled because the extraordinary rates are realized with large volume digital CMOS technology and copper based backplane design and technologies. CMOS technology is much lower cost than compound semiconductor used for optical sources. And copper backplanes are much cheaper and support denser signaling than CAT5 or CAT6 cables.

FIG. 5F shows that having a multiplicity of wide band mmWave channels available for use a datacenter, and two polarization to choose from, patch antenna arrays of modest directivity can be employed in an embodiment according to the teachings of this patent application. MmWave beams of 12 or 30 degrees widths will illuminate the targeted receiver at the other side of the aisle in full duplex point-to-point mmWave links, and will also illuminate the neighbor receivers in the same aisle. In order to avoid interference, the other communication parts in the same aisle use different mmWave carrier frequencies, i.e. different wide band mmWave channels in their communication. Since mmWave signals illuminating neighbor communication pairs will reflect at the servers' front panels, in one embodiment, those front panels are painted with a paint that absorbs or scatter the incoming mmWave beam. Hence, after several reflections, if a mmWave beam eventually reaches a unintended receiver using the same carrier frequency, the interfering signals will be highly attenuated and will not degrade the performance of the attacked mmWave link significantly.

The skilled in the art will recognize that many techniques can be used to mitigate further the interference between mmWave channels. FIG. 5G show a receded mount for pairs of patch antenna array supporting full duplex link operation. An interfering mmWave beam will be incident at an angle onto the front panel and will tend not to reach the receiving antenna array. Only the intended communication, with a direct beam will be incident at an angle that reaches the receiving antenna.

The skilled in the art will recognize that the full duplex mmWave link can be scaled to multiple beams and communication channels and associated antenna arrays in both directions of communication between a first and a second server in opposing racks. Moreover, in one embodiment, half the available channels can be used in one direction and the other half of the channels available used in the other direction for communication between said first and second servers in opposing racks for maximum data throughput. The skilled in the art will recognize that a third and a fourth communicating servers in opposing racks can re-use all those same available communication channels used by said first and second servers. In order to allow first and second server links to be positioned close to third and fourth server links, the skilled in the art will recognize interference can be avoided by the use of well-known coding techniques similar to those used in code-division multiple access (CDMA) cellular phone communications.

The skilled in the art will also recognize that in the interest of low latency communications in mmWave, and appreciating the mmWave links in the datacenter are point-to-point without physical obstacles, the baseband modem used in those mmWave transceivers might make use of advanced multi-carrier techniques like OFDM with a much more reduced number of carriers than typically used in open environments.

Since many full duplex mmWave beams will be active in the datacenter aisles, a person walking in the corridor between racks in the datacenter will be exposed to the mmWave radiation, and will also disrupt those communication links. Normal communication operation uses continuously operating mmWave beams. Once a person or object blocks the full duplex mmWave links, the mmWave transceivers affect will detect the obstruction by the absence of received signal. Upon such absence, each transceiver will switch to intermittent beam mode. Such an intermittent mode attends IEEE C95.1-2005 standards for mmWave safety. That's because the intermittent operation avoid dangerous heating of live tissue. Once the person or obstacle is removed from blocking the mmWave beams, the transceivers recognize the presence of received signal and switch back to normal operation.

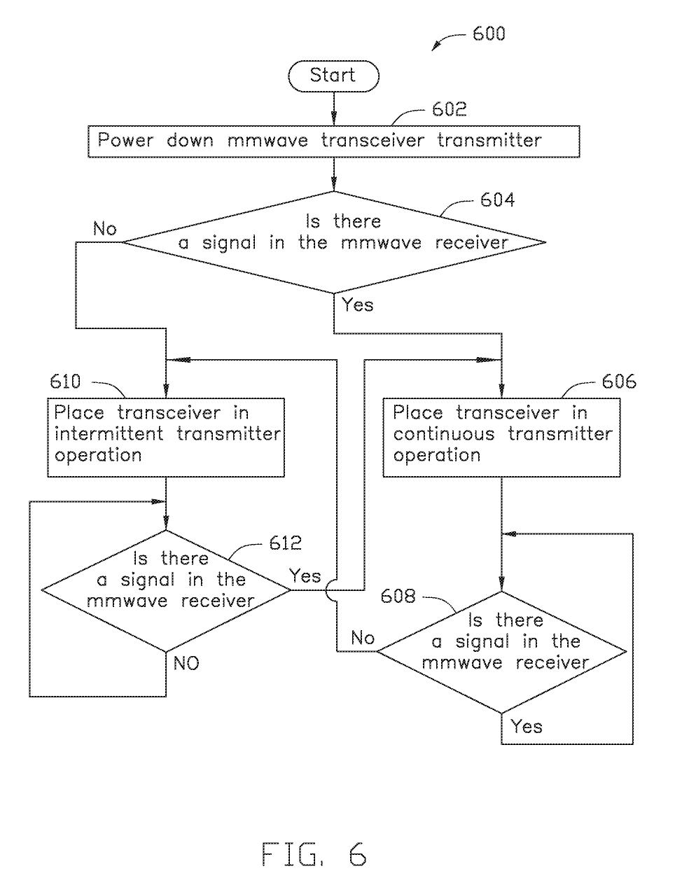

FIG. 6 is a flowchart 600 illustrating the operation of a HPDC 100 according to one embodiment. The HPDC 100 operates by initially powering down the mmWave transceiver transmitter as shown in box 602. The powering down occurs for about 10 seconds by turning off the transmitter. Simultaneously, the mmWave transceiver receiver is constantly operating to always be available to receive a signal. If no signal is detected, the transmitter is placed into intermittent operations mode in box 610. If a signal is detected in box 604, the transceiver is placed into continuous operations mode to in box 606 to send a return signal to the server sending the original signal that the original signal has been received and to transmit back a new signal of any requested information. So long as there is a signal received in box 608, the transceiver remains in continuous operation. If however, the signal stops, then the transceiver is placed into intermittent operation as shown in box 610. So long as there is no signal received in box 612, the transmitter remains in intermittent operation. In operation, all of the mmWave links (or communications paths 206) are full duplex links, and the receiver is always on. The transmitter, on the other hand, can either be off, in continuous operation, or in intermittent operation. The intermittent operation of the transmitter alternates the mmWave beam “on” for about 10 msec for example and off for about ten times the time that the beam was “on” for a duty cycle of about 10 percent or less.

For safety purposes, because a technician may need to enter the aisles 108 of the HPDC 100, the mmWave transmissions may occur at below about 10 mW. If there is a detection of any object in the aisle 108, the transmitter can change to either the off state or to the intermittent operation state. The detection occurs because no return signal is received at the server 102 from the server 102 to which the signal was original sent. Once the return signal is received, then the transmitter can return to continuous operation.

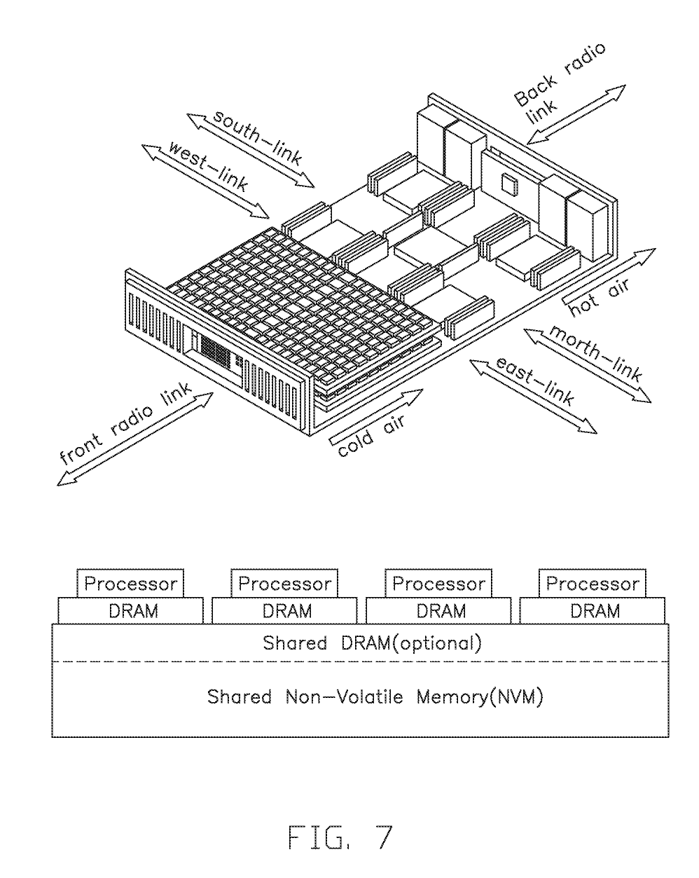

FIG. 7 shows how the invention taught in this patent application supports high level remote memory access (RMA) services. In one embodiment, each processor in a server has the local memory and a large quantity of shared memory that can be DRAM or a suitable non-volatile memory (NVM) technology. In one embodiment, the NVM technology is actually specifically designed for low latency readouts.

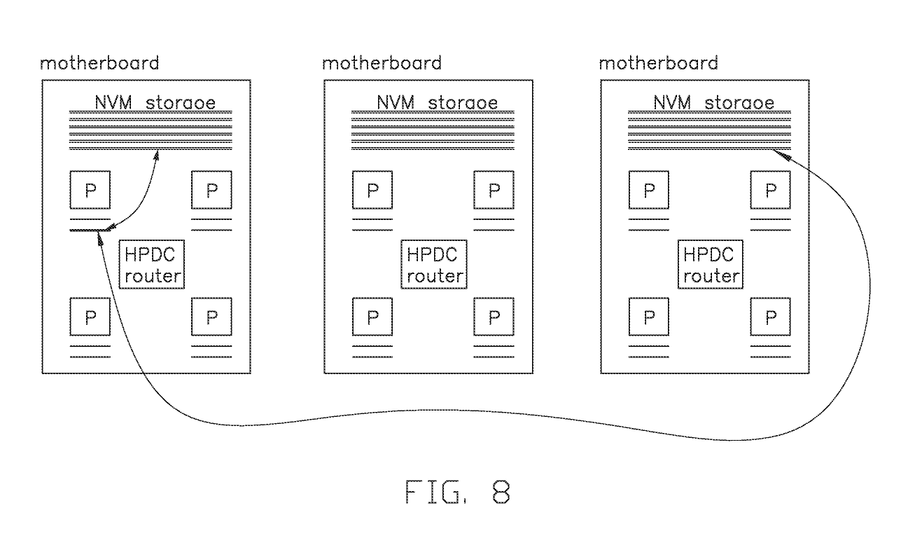

FIG. 8 shows an embodiment where the router chip (HPDC router) intercepts READ and WRITE commands and access either NVM storage on the same server motherboard or NVM storage on a remote motherboard. Global address is used and low latency network routing used is taught in a related patent application by the author. System low latency is achieved when this low latency network routing scheme is used with also low latency readout NVM storage.

In the embodiment of FIG. 8, a special memory DIMM card is added to each processor socket's memory bus. This special card responds to READ and WRITE commands on the memory bus as if it were an actual card populated with DRAM chips. Since, data fetched from a remote motherboard will be available at the local motherboard after a longer delay relative to data residing on local DRAM memory, the router implement a novel scheme in combination with new features in the processor memory controller. In one embodiment, the router will respond to a READ command to an address in a remote NVM storage by returning data with parity errors inserted beyond correction capabilities of the memory controller. The new memory controller in this embodiment will retry the READ command. Additional retries of READ commands might be issued till the data from the remote NVM is finally available at the local router. At this moment, the router will respond with the requested data without parity errors, completing the READ command response.

In one embodiment, at boot up time, as the BIOS system start procedure, or equivalent system starting procedure, when the boot up is testing valid memory addresses corresponding to remote NVM, the router will promptly respond with router-generated valid data, say “FF”. The router will not try to reach any remote NVM storage. The router will only respond promptly as if the remote NVM address being tested at boot up time is indeed present and functionally working correctly.

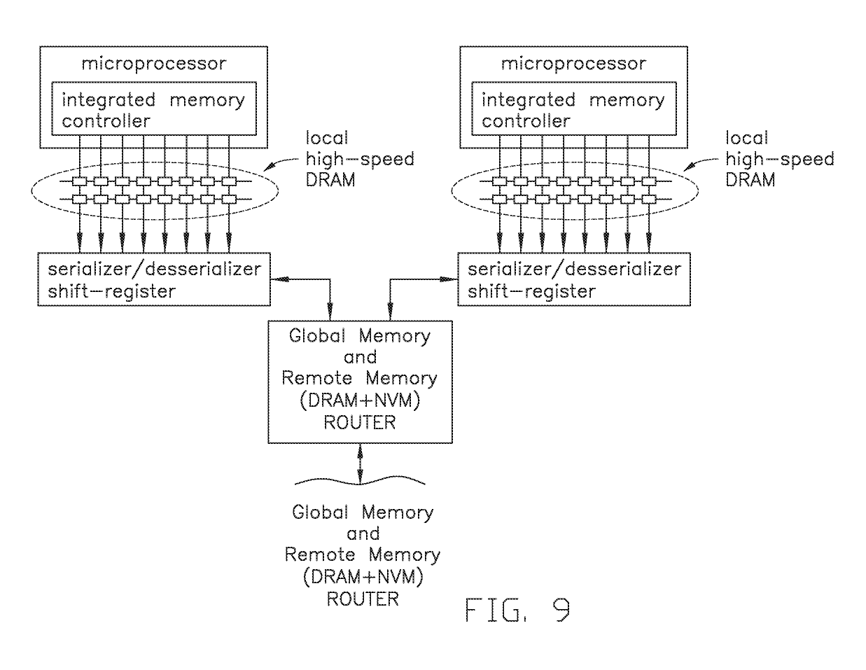

In multiprocessor motherboards with 64-bit processors, it may happen that each processor socket use two memory channels of 64 bit. In order to diminish the number of parallel lines from the memory bus in need to be routed to the HPDC router, the special card inserted in the memory bus, in one embodiment shown in FIG. 9, is equipped with circuits that can partially serialize those 64 bit channels into a 8-bit wide bus. This 8-bit bus is then routed to the HPDC router chip.

The use of mmWave for communications between servers removes the need for a significant amount of cables or fiber optics going up the rack and going across the ceiling over the aisle and down the opposing rack in a HPDC. The use of copper-based backplanes and using motherboard as backplanes for neighbor servers saves in cost and allows for much denser parallelization of signaling for high data throughput than would be reachable with cables. By using mmWave, there are no wires extending between servers in opposing aisles. Furthermore, by utilizing the ring or folded ring connection arrangements, physical connections between each and every server are not necessary. Therefore, the total number of “wired” communication lines is equal to 2 times the total number of servers present in the HPDC. With less wires, a more efficient HPDC can be achieved, and a much easier setup of the HPDC occurs. In a related patent application by the author, those shorter wired links between servers uses special signaling scheme that creates virtual circuits essentially making all the servers work as if they are all connected by point-to-point wires. This avoids the use of switch boxes in the racks, and each server reaches for local and remote NVM as if they had dedicated wired channels to those. The skilled in the art will recognize that this feature of the routing network being as if all-connected avoids contention. Latency in the network is therefore the same with the network unloaded or fully loaded by intense traffic of data. Furthermore, mmWaves are advantageous over optical fibers for connections across aisles because optical fibers have a wide bandwidth, but the light source is around 10 Gbits per second. MmWaves can be as great as 20 Gbits per second. Because the HPDC is within a building and not out in the open, the mmWaves will not need to be limited to the FCC's ISM bands bandwidth limitations, but rather, can use just about any other range of suitable mmWave frequencies. Furthermore, the mmWaves can be on different bands so that there is no interference between servers within a stack when receiving a signal. With the use of mmWaves and the ring or folded connection arrangements, neither switches nor cables are needed to route data within the HPDC.

While the foregoing is directed to embodiments of the present disclosure, other and further embodiments of the disclosure may be devised without departing from the basic scope thereof, and the scope thereof is determined by the claims that follow.

What is claimed is:

1. A datacenter computer, comprising:
a first server, wherein the first server comprises a first mmWave antenna/receiver;
a second server physically coupled to the first server, wherein the second server comprises a second mmWave antenna/receiver; and
a third server physically spaced from the first and second servers, wherein the third server comprises a third mmWave antenna/receiver, wherein the first mmWave antenna/receiver is both horizontally and vertically aligned with the third mmWave antenna/receiver.

2. The datacenter computer of claim 1, wherein the first mmWave antenna/receiver is a patch antenna array mounted on the first server.

3. The datacenter computer of claim 1, wherein the first mmWave antenna/receiver has a first carrier frequency and the third mmWave antenna/receiver has a second carrier frequency that is different from the first carrier frequency.

4. The datacenter computer of claim 1, wherein the first server is coupled to the second server with point-to-point communication links, wherein said communication links comprise two unidirectional communications channels.

5. The datacenter computer of claim 1, wherein the first server is disposed in a first stack, wherein the first stack has a front panel, and wherein the first mmWave antenna/receiver is recessed from the front panel.

6. The datacenter computer of claim 5, wherein the front panel has passages therein and wherein the front panel has mmWave absorbing and scattering paint thereon.

7. A datacenter computer, comprising:
a plurality of servers, wherein the servers are arranged in a plurality of stacks, wherein the plurality of stacks are arranged in a plurality of rows, wherein within each stack a first plurality of servers of the plurality of servers are coupled together with a physical connection, wherein within each row adjacent stacks that each have a plurality of servers are coupled together with a physical connection, wherein adjacent rows are spaced apart, wherein a first server in a first row is both vertically aligned and horizontally aligned with a second server in a second row, and wherein the first server has a first mmWave antenna/receiver that is both vertically aligned and horizontally aligned with a second mmWave antenna/receiver that is disposed in the second server.

8. The datacenter computer of claim 7, wherein the first mmWave antenna/receiver is a patch antenna array mounted on the first server.

9. The datacenter computer of claim 7, wherein the first mmWave antenna/receiver has a first carrier frequency and the second mmWave antenna/receiver has a second carrier frequency that is different from the first carrier frequency.

10. The datacenter computer of claim 7, wherein the first plurality of servers are coupled together with point-to-point communication links, and wherein said communication links comprise two unidirectional communications channels.

11. The datacenter computer of claim 10, wherein the first plurality of servers comprises 5 servers.

12. The datacenter computer of claim 7, wherein the first plurality of servers are coupled to a second plurality of servers disposed within the same row, wherein the first plurality of servers are coupled to the second plurality of servers with point-to-point communication links, wherein said communication links comprise two unidirectional communications channels.

13. The datacenter computer of claim 12, wherein the first plurality of servers comprises 5 servers.

14. The datacenter computer of claim 7, wherein the first server is disposed in a first stack, wherein the first stack has a front panel, and wherein the first mmWave antenna/receiver is recessed from the front panel.

15. The datacenter computer of claim 14, wherein the front panel has passages therein and wherein the front panel has mmWave absorbing and scattering paint thereon.

16. A datacenter computer, comprising:
a first stack of servers, wherein the first stack of servers comprises a plurality of first servers, wherein a first server and a second server of the plurality of first servers are physically coupled together, wherein the first server comprises a first mmWave antenna/receiver and the second server comprises a second mmWave antenna/receiver;
a second stack of servers disposed adjacent the first stack of servers, wherein the second stack of servers comprises a plurality of second servers, wherein a third server and a fourth server of the plurality of second servers are physically coupled together, wherein the first server is physically coupled to the third server, wherein the third server comprises a third mmWave antenna/receiver and the fourth server comprises a fourth mmWave antenna/receiver; and
a third stack of servers disposed adjacent the first stack of servers, wherein the third stack of servers comprises a plurality of third servers, wherein a fifth server and a sixth server of the plurality of third servers are physically coupled together, wherein the first stack of servers and the second stack of servers are arranged in first row, wherein the third stack of servers is a part of a second row distinct from and spaced from the first row, wherein the fifth server comprises a fifth mmWave antenna/receiver and the sixth server comprises a sixth mmWave antenna/receiver, and wherein the first mmWave antenna/receiver is both vertically and horizontally aligned with the fifth mmWave antenna/receiver.

17. The datacenter computer of claim 16, wherein the first mmWave antenna/receiver is a patch antenna array mounted on the first server.

18. The datacenter computer of claim 16, wherein the first mmWave antenna/receiver has a first carrier frequency and the fifth mmWave antenna/receiver has a second carrier frequency that is different from the first carrier frequency.

19. The datacenter computer of claim 16, wherein the first stack of servers are coupled together with point-to-point communication links, and wherein said communication links comprise two unidirectional communications channels.

20. The datacenter computer of claim 19, wherein the first stack of servers comprises 5 servers.

21. The datacenter computer of claim 16, wherein the first stack of servers are coupled to the second stack of servers, wherein the first stack of servers are coupled to the second stack of servers with point-to-point communication links, wherein said communication links comprise two unidirectional communications channels.

22. The datacenter computer of claim 21, wherein the first stack of servers comprises 5 servers.

23. The datacenter computer of claim 16, wherein the first stack of servers has a front panel, and wherein the first mmWave antenna/receiver is recessed from the front panel.

24. The datacenter computer of claim 23, wherein the front panel has passages therein and wherein the front panel has mmWave absorbing and scattering paint thereon.
